(19) United States
(12) Patent Application Publication
(10) Pub. No.: US 2007/0070947 A1
(43) Pub. Date: Mar. 29, 2007

(54) Method for set maintainance by mobile station in mobile communication system, and pilot channel searcher block using the same

(75) Inventor: So-Hyun Park, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/529,735

(22) Filed: Sep. 29, 2006

(30) Foreign Application Priority Data
Sep. 29, 2005 (KR) 2005-91327

(51) Int. Cl. H04Q 7/00

(52) U.S. Cl. 370/331

(57) ABSTRACT

A method for maintaining a set by a mobile station in a mobile communication system, and a pilot channel searcher block using the same are provided. The method includes receiving a pilot signal from a base station of at least one active set, checking a variation of a path position that is a temporal point where a main peak of the pilot signal is positioned, for a time period and controlling a set search range depending on a change value of the path positon.

### CROSS-REFERENCE TO RELATED APPLICATIONS

This application claims the benefit under 35 U.S.C. § 119(a) of Korean Patent Application No. 2005-91327 filed Sep. 29, 2005, in the Korean Intellectual Property Office, the entire disclosure of which is hereby incorporated by reference.

### BACKGROUND OF THE INVENTION

1. Field of the Invention:

The present invention relates generally to a method and device for searching a neighbor base station in a mobile communication system. More particularly, the present invention relates to a method for set maintenance in a mobile station, and a pilot channel searcher block using the same.

2. Description of the Related Art:

In general, a mobile communication system enables a call even when a subscriber moves at a high speed over a wide area. Typical of such mobile communication systems is a cellular system. The cellular system refers to a system for dividing a service area into several smaller areas, that is, cells, and using the same frequency band in two cells sufficiently distant away from each other, thereby spatially reusing a frequency. It is a concept suggested to overcome a limitation of a service area and a limitation of subscriber capacity in a conventional mobile communication system. In the history of cellular systems, a technology that first appeared was an analog type such as an advance mobile phone system (AMPS) and total access communication services (TACS). Such technology is called a 1st generation mobile communication. The 1st generation mobile communication system experienced difficultly holding mobile communication service subscribers which increased rapidly. Also, technology developments brought increased requests for not only an existing voice service but also various additional services. The requests brought about the appearance of a 2nd generation mobile communication. The 2^{nd} generation is a digital type and is an improvement of the 1st generation mobile communication. Unlike the analog system, a 2nd generation mobile communication system digitalizes an analog voice signal, performs voice coding, and performs a digital modulation/demodulation. The 2^{nd} generation uses a frequency of a 800 MHz band and uses a multi access method which employs a time division multiple access (TDMA) method, and a code division multiple access (CDMA) method. The 2nd generation mobile communication system provides a voice service and a low speed data service, and is based on IS-95 (CDMA method) and IS-54 (TDMA method) in the U.S. and a Global System for Mobile communication (GSM) method in Europe. A personal communication services (PCS) system is classified as a 2.5th generation mobile communication system, and uses a frequency of a 1.8 GHz to 2 GHz band. The 2nd generation mobile communication system is provided for the purpose of providing voice service to users while increasing an efficiency of the mobile communication system.

In general, in a CDMA mobile communication system, each base station has the same spread code and transmits short PN codes (hereinafter, referred to as “pilot channel signal”) having mutually different delays, that is, pilot offsets (PN offsets), to a mobile station (MS). The mobile station searches the pilot channel signals, recognizes a specific base station, synchronizes with the base station, and performs a communication. In the CDMA system, the MS corresponds to a multi-path. When moving to another cell, the MS needs to continue monitoring pilot channel signal strengths (Echo) of an in-service base station and peripheral base stations in order to execute a handoff and maintain call stability. In the CDMA system, the number of pilot offsets used by the base stations is 512 in total. Each base station is assigned one pilot offset. In the CDMA system, the pilot offsets are divided into four sets: an active set, a candidate set, a neighbor set, and a remaining set. The pilot offsets are maintained by the MS.

The active set (hereinafter, referred to as “A set”) refers to a set of the pilot offsets of the base stations which are currently assigned a traffic channel with the MS, or from which the MS receives a sync channel or a paging channel.

The neighbor set (hereinafter, referred to as “N set”) refers to a set of the pilot offsets of the base stations peripheral to the base station belonging to the A set. The base station belonging to the A set transmits a message to the MS for notification of the N set.

The candidate set (hereinafter, referred to as “C set”) refers to a set of the pilot offsets among the N sets, in which a strength of the pilot signal is greater than a predetermined threshold. The MS keeps monitoring and updating the candidate set.

The remaining set (hereinafter, referred to as “R set”) refers to a set of remaining pilot offsets not included in the other three sets: the A set, the N set, and the C set.

A series of processes of monitoring the four sets of pilot signals by the MS, and updating the set depending on the monitoring result or requesting the base station for a handoff, is collectively called set maintenance.

The MS applies a predetermined search window to a specific pilot offset, measures the strength of the pilot signal received using the multi-path, adds up all of the measured strengths, and regards the result as an energy of the pilot signal.

Such a series of steps is called a pilot search. A pilot search is performed by a searcher block provided within a modem of the MS. A PN position is updated through a periodical search, and a rake receiver receives data through the updated PN position, thereby maintaining the quality of a call.

In the CDMA mobile communication system, the set maintenance is performed for the A set, the C set, the N set, and the R set specified in standard IS 95A and B, and CDMA2000 high rate data air interface spec. A conventional process of searching the peripheral base station in the MS will be described with reference to FIG. 1.

FIG. 1 is a flowchart illustrating a conventional method for maintaining a set by the MS in the mobile communication system.

In step 100, the MS searches all lists of the A set included in a channel assign message (CAM) and a handoff direction message (HDM) received from an adjacent base station. In step 102, the MS searches all of the C sets where a reception strength of the pilot signal is less than a predetermined threshold in the A set.

In step 104, the MS searches all of the N sets included in a neighbor list update message (NLUM) and a neighbor list message (NLM) received from the base station, then returns to step 100 and repeatedly performs the above steps.

FIG. 1 shows the method for searching the N set several times once, but the MS can maintain the set by searching all of the A set and the C set and searching the N set one by one depending on its embodied method.

In a case where the MS searches the N sets one by one and performs the set maintenance, a process will be performed as follows. In FIG. 1, the A sets are all searched in the step 100, the C set are all searched in the step 102, and then only one N set is searched in the step 104. Again, the steps 100 and 102 are performed. In the step 104, a second N set is again searched, and the step 100 is again performed. If the predetermined N sets are all searched during execution of the above steps, one R set is searched. A search index of the N set is reset to “0” to again search the N set from the beginning, and the step 100 is again performed.

FIG. 1 shows a conventional and fundamental technology. The search operation is periodically repeated until the MS is in a call state after receiving the pilot signal.

FIG. 2 illustrates a conventional search period when the set is maintained in the mobile station. In FIG. 2, a duration from Ti where an A set 0 is initially measured, to T2 where the A set 0 is again measured is called a search period of the A set 0 of the MS.

FIG. 2 shows the search period of the MS on the assumption of three A sets, two C sets, and four N sets. In case where the number of preset sets is different from above, the search period will be different as well.

In general, the reason why the MS maintains a few sets depending on the pilot signal and periodically updates energy or PN position information of the pilot signal is to keep the call when the user is at a stop or is in movement (that is, under multi-path environments or fading environments), and guaranteeing a high quality of call.

In the conventional set search depending on the set maintenance shown in FIG. 1, a predetermined number of the sets are searched for a predetermined period, irrespective of a user's movement state. Approximately 90% or more of a time taken for the user to actually enable the MS is a stable stop state, not a multi path or a fading state. Thus, the set maintenance of the same pattern is ineffective.

Accordingly, there is a need for an improved pilot channel searcher block and method for maintaining a set in a mobile communication system.

### SUMMARY OF THE INVENTION

It is, therefore, an exemplary object of the present invention to provide a method and device for set maintenance for a plurality of base stations by a mobile station in a mobile communication system.

It is another exemplary object of the present invention to provide a method and device for changing a range of a set to be maintained, depending on a mobility of a mobile station in a mobile communication system.

To achieve the above and other exemplary objects, there is provided an exemplary method for maintaining pilot offsets in a mobile station of a mobile communication system. The exemplary method includes receiving a pilot signal from a base station of at least one active set, and checking a variation of a path position that is a temporal point where a main peak of the pilot signal is positioned, for a time period and controlling a set search range depending on a change value of the path position.

In another exemplary aspect of the present invention, there is provided a pilot channel searcher block of a mobile station for maintaining pilot offsets in a mobile communication system. The exemplary searcher block includes a despreader for receiving a pilot channel signal from base stations of at least one active set through an antenna, and despreading an I (In-phase) component and a Q (Quadrature) component of the received pilot channel signal using PN codes, a PN generator for generating the PN codes depending on a control signal, a coherent accumulator for accumulating the despreaded signals, an energy calculator for calculating an energy value of the accumulated signals, a non-coherent accumulator for accumulating the calculated energy value for a time period, and calculating an average energy value, a sorter for sorting the average energy value for the pilot offsets and a controller for receiving the pilot signal from the base stations, checking a variation of a path position that is a temporal point where a main peak of the pilot signal is positioned, for a time period, and controlling a set search range depending on a change value of the path position.

### BRIEF DESCRIPTION OF THE DRAWINGS

The above and other objects, features and advantages of certain embodiments of the present invention will become more apparent from the following detailed description when taken in conjunction with the accompanying drawings in which:

FIG. 1 is a flowchart illustrating a conventional method for maintaining a set by a mobile station in a mobile communication system;

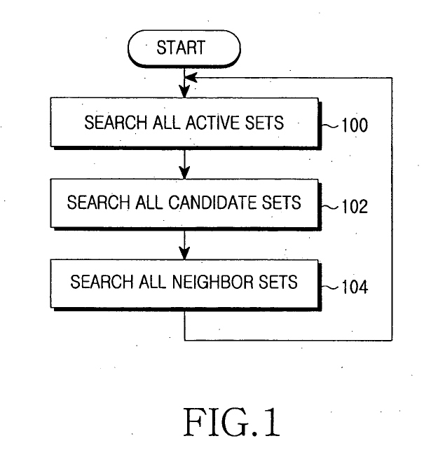

FIG. 2 illustrates a conventional search period when a set is maintained in a mobile station;

FIG. 3 is a flowchart illustrating a method for maintaining a set by a mobile station, to describe a basic concept of set maintenance according to an exemplary embodiment of the present invention;

FIG. 4 is a flowchart illustrating a method for maintaining a set by a mobile station according to an exemplary embodiment of the present invention;

FIG. 5 illustrates a method for changing a search mode and reducing the number of sets to be searched for set maintenance by a mobile station according to an exemplary embodiment of the present invention;

FIG. 6 illustrates a method for changing a search mode and reducing a search rate for set maintenance by a mobile station according to an exemplary embodiment of the present invention;

FIG. 7 is a block diagram illustrating a construction of a pilot channel searcher block according to an exemplary embodiment of the present invention; and

FIG. 8 is a block diagram illustrating a construction of a controller according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness. Exemplary embodiments of the present invention will now be described in detail with reference to the annexed drawings.

First, an exemplary concept of the present invention will be described. By searching and maintaining pilot offsets distinguished into existing A, C, N, and R sets, an exemplary embodiment of the present invention periodically determines a reception power and a path position of a pilot signal received from a base station that is the A set while calculating a stability of a mobile station (MS), and differentiates a search rate or a scheduling depending on the calculated stability. Path refers to a path through which the MS receives the pilot signal from a neighbor base station. The path position refers to a temporal point where a main peak of the pilot signal received from the neighbor base station is positioned. In other words, it can be determined by the path position whether the main peak of the pilot signal is far away (for example, as measured by chips) depending on a PN offset. Exemplary embodiments of the present invention are characterized by performing the set maintenance using the path position. In an exemplary embodiment of the present invention, when an amount of variation of the path position or the number of times the variation is greater than a certain reference value, the MS is determined to currently have a high mobility, and its typical set maintenance is performed. When the amount of the variation of the path position or the number of the times of the variation is less than the certain value, the MS is determined to currently have a low mobility, and its typical set maintenance need not be performed. In an exemplary embodiment of the present invention as described below, the amount of the variation of the path position or the number of times of the variation are integrally used as a term of a change value. The number of accumulation chips representing a range of change of the path position may also be used as the change value. In an exemplary embodiment of the present invention, the MS compares the change value of the path position with a threshold, and determines whether a user is in movement or at a stop.

When the calculation result is that the MS has a high stability, that is, the MS has low mobility, the MS reduces the ranges of the sets to be searched, and shortens the search periods of the sets. Accordingly, more exact position information can be obtained. Alternatively, when the search period is fixed and the number of the sets is reduced, the number of times a search is performed in a time period can be reduced, thereby obtaining a gain in resource.

When the MS has a low stability, that is, the MS has high mobility, the ranges of the sets to be searched can be relatively increased, and a quality of a call can be maintained even when the MS moves at a high speed.

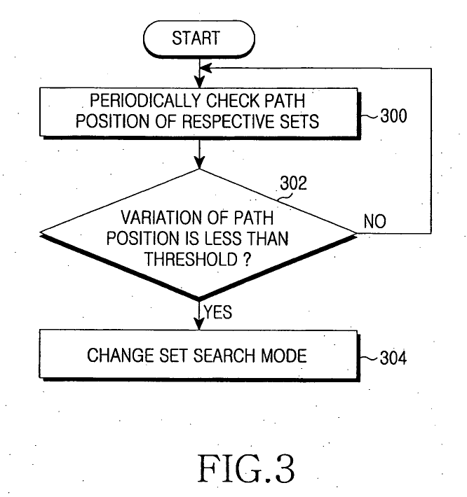

An exemplary embodiment of the present invention will be described with reference to FIG. 3.

FIG. 3 is a flowchart illustrating a method for maintaining the set by the MS, to describe the basic concept of the set maintenance according to an exemplary embodiment of the present invention. FIG. 3 is a simple flowchart for describing a concept of the present invention. A detailed description of an operation will be made below.

In an exemplary embodiment of the present invention, in consideration of a stream of a PN time of the pilot signal received from the base station belonging to each set, that is, in consideration of a variation of time for receiving the PN offset, the MS determines its current motion state, and changes the search rate and the range of the set to be searched. When the pilot signals received from the base stations keep the same path position for a time period, that is, when the change value of the path position is less than a threshold, the MS determines that the user is at a stop and is not under multi path environments, and changes from a conventional search mode to an exemplary search mode of the present invention. When the path position of the pilot signal received from the base station of the respective sets is unstable, that is, when the change value of the path position is greater than the threshold, the MS converts to the conventional search mode for performing a handoff without deteriorating the call quality even when it moves at a high speed. An exemplary changed search mode will be described in detail below.

In step 300, the MS periodically checks the path position for the pilot signal of each set. In step 302, the MS determines whether or not the change value of the path position is less than a threshold, for a time period. When it is determined that the change value of the path position is less than the threshold for the time period in step 302, in step 304, the MS changes the search mode to the set search mode according to an exemplary embodiment of the present invention. The changed set search mode of step 304 will be described in detail below.

When it is determined that the change value of the path position is greater than the threshold in step 302, the MS returns to step 300, and repeatedly performs steps 300 and 302.

When it is determined that the change value of the path position is less than the threshold, the MS determines that it currently has high stability, and reduces the number of sets to be searched or increases the search period according to an exemplary embodiment of the present invention. The threshold may be set using a field test of an MS manufacturer. The threshold can be set within the MS in manufacture, can be later set within the MS by an upgrading method or can be set by any other appropriate method. When it is determined that the change value of the path position is less than the threshold, the MS determines that the user is substantially stopped. This means that the MS has high stability in this specification. When it is determined that the change value of the path position is greater than the threshold, the MS determines that the user is moving, that is, the MS has the high mobility. This means that the MS has low stability in this specification.

The maximum number of the A sets specified in the standard is 6, the maximum number of the N sets is 40, and the maximum number of the C sets is, though not specified, about 10. The A set and the C set need a certain level or more of the search rate to optimize a communication performance and prevent a call drop when the MS moves.

In an exemplary embodiment of the present invention, it is assumed that the number of the A sets to be searched by the MS is 3, the number of the C sets is 2, and the number of the N sets is 4.

Among exemplary embodiments of the present invention for changing the search mode, a first exemplary embodiment for controlling the number of the sets to be searched depending on the stability measured by the MS, and a second exemplary embodiment for controlling the search rate depending on the stability measured by the MS will be described.

A method for maintaining the set in the MS according to an exemplary embodiment of the present invention will be described with reference to the accompanying drawings below.

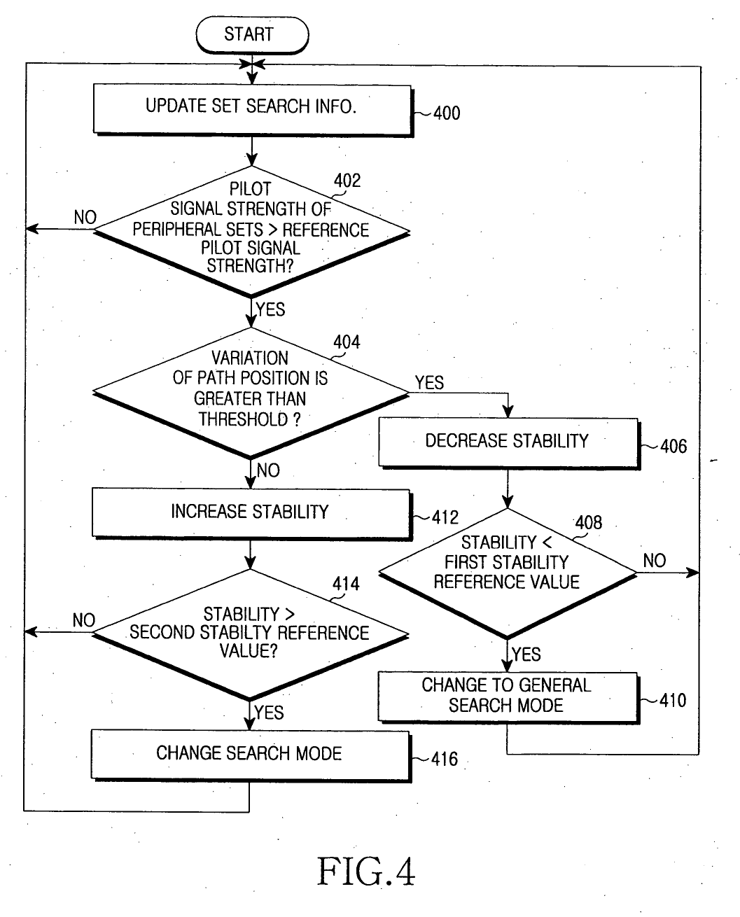

FIG. 4 is a flowchart illustrating a method for maintaining the set by the MS according to an exemplary embodiment of the present invention.

In step 400, the MS updates path position and pilot signal strength information of the pilot signals received from the base stations of peripheral sets. In step 402, the MS determines whether or not the pilot signal strength received from the base stations belonging to the peripheral sets is greater than a reference pilot signal strength. The reason why it is determined whether or not the received pilot signal strength is greater than the reference pilot signal strength in step 402 is as follows. When the pilot signal strength is less than the reference pilot signal strength, the MS has difficulty measuring the path position and thus, cannot achieve an effect of the present invention.

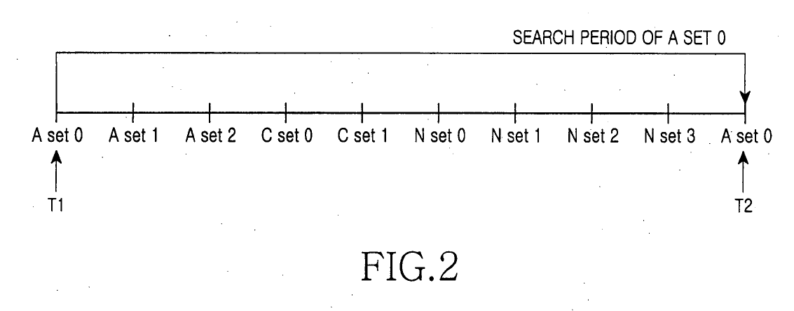

In step 404, the MS determines whether or not the change value of the path position is greater than the threshold. The change value of the path position refers to a difference between a path of an A set 0 measured by the MS at a time point (T1) and a path of an A set 0 measured at a time point (T2) in FIG. 2 as described above.

The threshold may be an experimental value determined using a field test of the MS manufacturer.

When the change value of the path position is greater than the threshold in the step 404, the MS reduces the stability in step 406. In step 408, the MS determines whether or not the reduced stability of step 406 is less than a first stability reference value. When the stability is less than the first stability reference value in step 408, it signifies that the MS is moving at a high speed. Thus, in step 410, the MS searches the base station belonging to the peripheral sets using the conventional search mode. When the stability is not less than the first stability reference value, the MS does not need to search the base stations belonging to the broad sets as in a conventional art. Thus, the MS again proceeds with step 400 and updates set search information without changing the search mode.

When it is determined that the change value of the path position is less than the threshold in step 404, the MS increases the stability in step 412. When it is determined that the increased stability of step 412 is greater than a second stability reference value in step 414, the MS changes the set search mode in step 416. When it is determined that the stability is less than the second stability reference value in step 414, the MS returns to step 400. A list of the N sets is stored in a memory described later in preparation for a case where the MS merely changes only the search mode in step 416 and reduces the stability, that is, for a case where the MS converts to a movement state.

For convenience, in the description above, the threshold compared with the stability of the MS separately uses a first stability reference value and a second stability reference value. However the threshold can use the same reference value as well. The first stability reference value is a reference for changing the set search mode into the conventional search mode when the MS frequently moves and thus the change value of the path position is greater than the threshold. The second stability reference value is a reference for changing the set search mode into the set search mode according to an exemplary embodiment of the present invention when the MS is in an almost motionless state and thus the change value of the path position is less than the threshold.

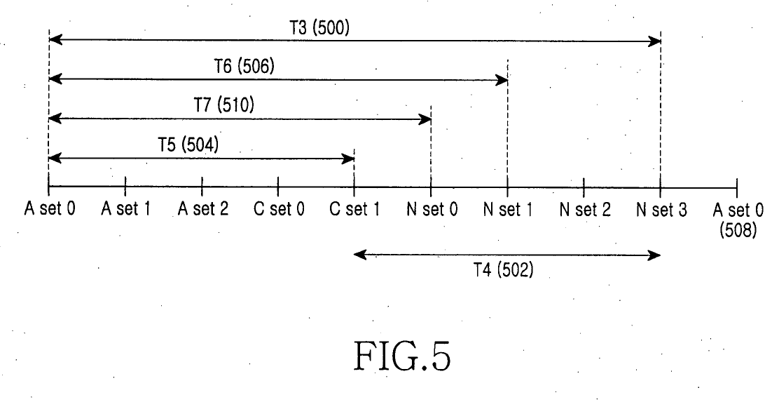

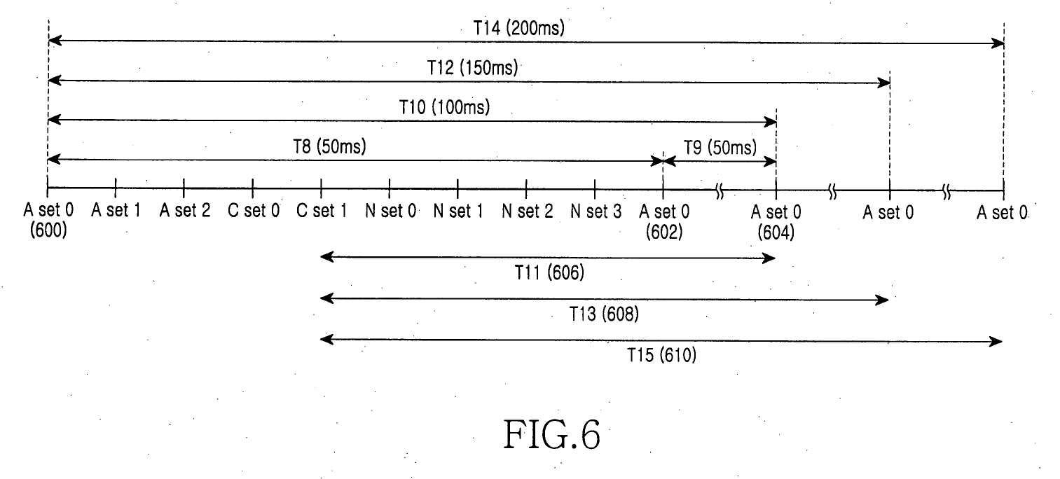

A method for changing the search mode in step 416 of FIG. 4 according to a first and second exemplary embodiment of the present invention will be respectively described with reference to FIGS. 5 and 6 below.

In FIGS. 5 and 6, it is assumed that the number of the sets maintained by the MS is 3 for the A set, 2 for the C set, and 4 for the N set as exemplified above.

FIG. 5 illustrates a method for changing the search mode and reducing the number of the sets to be searched for the set maintenance by the MS according to a first exemplary embodiment of the present invention. Since the MS determines that the stability increases in step 414, the range of the set to be searched is reduced. FIG. 5 exemplifies a method for reducing the number of the N sets to be searched.

The number of the N sets to be searched can be controlled depending on the stability, that is, the mobility of the MS. A description will be made on the assumption that the MS does not search all of the four N sets.

T3 500 denotes a search range in which the MS searches the sets in the general search mode as described in FIG. 2. T5 504 denotes a search range in which the MS searches the sets in step 416 of FIG. 4 according to an exemplary embodiment of the present invention. Accordingly, T4 502 denotes the number of the N sets that the MS does not search according to an exemplary embodiment of the present invention. As shown in FIG. 5, the MS searches only the search range of the T5 504 and then, directly searches an A set 0 508. Thus, the MS reduces the range of the sets to be searched, thereby shortening the period for which one set is searched. Thus, the receiver of the MS, described later, can demodulate the pilot signal of the base stations belonging to the peripheral sets through a more accurate path.

In the above description, the MS does not search all of the four N sets in the first exemplary embodiment, but the number of the N sets to be searched can be controlled depending on the stability. The MS can control the set search range in various methods in which the number of the N sets to be searched is set to “2” like T6 506 of FIG. 5, or is set to “1” like T7 510 depending on the determined stability.

FIG. 4 exemplifies that the N set is not searched when the stability is greater than the second stability reference value. However, the MS can divide the stability reference value to be compared with the increased stability of step 412, into several levels, and reduce the number of the N sets to be searched on a per-level basis. For example, the MS can divide the stability reference value to be compared with the increased stability of step 412, into three levels: a variable search mode 1, a variable search mode 2, and a variable search mode 3, and can differently control the range of the set to be searched when the increased stability of step 412 exceeds the variable search mode 1, the variable search mode 2, and the variable search mode 3, respectively.

For example, in the first exemplary embodiment, the MS reduces the number of the N sets to be searched to “2” when the increased stability exceeds a reference value of the variable search mode 1, and the MS reduces the number of the N sets to be searched to “1” when the increased stability exceeds a reference value of the variable search mode 2. The MS does not search the N sets when the increased stability exceeds a reference value of the variable search mode 3.

A method for controlling the set range to be searched on the basis of the mobility actually measured by the MS according to a first exemplary embodiment of the present invention is described below.

The MS determines the stability only by the change value of the path position of the A sets in step 404. When it is determined that an average path position of the pilot signals received from the base stations of the sets changes more than ten chips within 100 milliseconds (ms), the MS determines that it moves at a high speed and keeps the general search mode for searching all the peripheral sets.

The MS determines the stability only by the change value of the path position of the pilot signal received from the base stations belonging to the A sets and the C sets in step 404. When it is determined that the average path position of the pilot signals received from the base stations of the sets changes less than one chip within 100 ms, the MS determines that its movement is low. The MS sets the search mode to the variable search mode 1, and reduces the number of the N sets to be searched, from 4 to 2, or generally by half.

The MS determines the stability only by the change value of the path position of the pilot signal received from the base stations belonging to the A sets and the C sets in step 404. When it is determined that the average path position of the pilot signals received from the base stations of the sets changes less than one chip for one minute, the MS is in an almost motionless state and thus, sets the search mode to the variable search mode 2 and searches the N sets of the number less than that of the variable search mode 1, that is, only a single N set.

The MS determines the stability only by the change value of the path position of the pilot signal received from the base stations belonging to the A sets and the C sets in step 404. When it is determined that the average path position of the pilot signals received from the base stations of the sets changes less than one chip for 10 minutes, the MS is at a stop and thus, sets the search mode to the variable search mode 3 and does not search the N set.

FIG. 6 illustrates a method for changing a search mode and reducing a search rate for set maintenance by a MS according to a second exemplary embodiment of the present invention.

Before describing another exemplary embodiment with reference to FIG. 6, it is assumed that a period for which the MS searches base stations belonging to respective sets in a general search mode is T8 (50 ms). The period for the MS operating in the general search mode for searching an A set 0 is 50 ms. At first, the MS searches the A set 0 in a position 600 and then, searches the A set 0 in a position 602 and then, searches the A set 0 in a position 604 after a duration of T9.

When the MS determines that the stability is high and changes the search mode, the MS does not search base stations belonging to peripheral sets during a duration of T11 606. Thus, the MS can save a battery or a resource of a controller of the MS, described later, during the duration time.

Accordingly, as described above, changing the search mode, the MS increases the search period, that is, decreases the search rate, of searching the peripheral sets.

As described in FIG. 5, even in FIG. 6, the MS can compare a stability with a stability reference value by several levels, thereby increasing or decreasing the search period.

FIG. 4 exemplifies that the N set is not searched when the stability is greater than the second stability reference value. The MS divides the stability reference value to be compared with the increased stability of step 412, into several levels, and controls the search rate on the per-level basis. It will be obvious to those having an ordinary knowledge in the art that the search period is shortened when the search rate is high and, to the contrary, the search period is lengthened when the search rate is low.

For example, the MS can divide the stability reference value to be compared with the increased stability of step 412, into three levels: the variable search mode 1, the variable search mode 2, and the variable search mode 3. The MS can control the search rate when the increased stability of step 412 exceeds the respective levels.

A method for controlling the search rate or the search period on the basis of a mobility actually measured by the MS according to a second exemplary embodiment of the present invention is described below.

The MS determines the stability by the change value of the path position of the pilot signal of the base stations belonging to the A sets in step 404 of FIG. 4. When it is determined that an average path position of the pilot signals received from the base stations belonging to the sets changes more than ten chips during 100 milliseconds (ms), the MS determines that it moves at a high speed and keeps a general search mode for searching the base stations belonging to the peripheral sets by an interval of 50 ms.

The MS determines the stability by the change value of the path position of the pilot signal received from the base stations belonging to the A sets and the C sets in step 404. When it is determined that the change value of the average path position of the pilot signals received from the base stations belonging to the sets changes less than one chip during 100 ms, the MS determines that its movement is low, sets the search mode to the variable search mode 1, reduces the search rate by half lower than the search rate of the general search mode, and searches the base station. Searching in the variable search mode 1, the MS has a search period of T1O (100 ms) increasing by twice in FIG. 6. Searching in the variable search mode 1, the MS can save a resource as much as a duration of T11 606.

The MS determines the stability by the change value of the path position of the pilot signal received from the base stations belonging to the A sets and the C sets in step 404. When it is determined that the change value of the average path position of the pilot signals received from the base stations of the sets changes less than one chip for one minute, the MS is in almost motionless state. Thus, the MS operates in the variable search mode 2 for making the search rate lower than that of the variable search mode 1, that is, increasing the search period and searching the sets. The MS searches the base stations belonging to the sets by a T12 (150 ms) increasing by three times of the search period higher than that of the variable search mode 1. Operating in the variable search mode 2, the MS can save a resource as much as a T13 608.

The MS determines the stability by the change value of the path position of the pilot signal received from the A sets and the C sets in step 404. When it is determined that the change value of the average path position of the pilot signals received from the base stations of the sets changes less than one chip for 10 minutes, the MS is at a stop. Thus, the MS operates in the variable search mode 3 and searches the base stations of the sets by an interval of a T14 (200 ms) increasing by four times of 50 ms that is a general search period. Operating in the variable search mode 3, the MS can save a resource as much as a duration of T15 610.

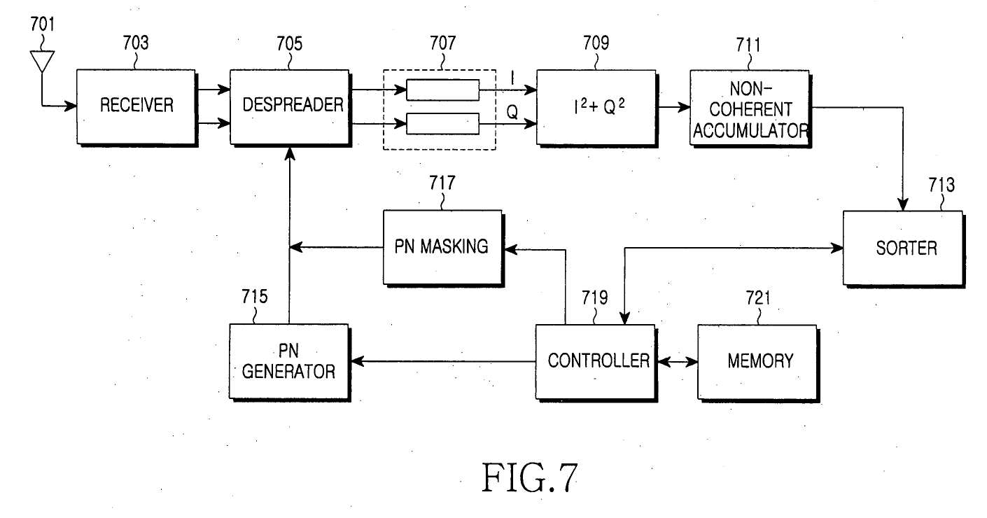

A method for controlling the search period according to the second exemplary embodiment of the present invention can be achieved by inputting a time period to a timer by a controller described later, and determining whether or not the timer counts the time period. This method will be described with reference to FIG. 7 below.

FIG. 7 is a block diagram illustrating a construction of a pilot channel searcher block according to an exemplary embodiment of the present invention. The pilot channel searcher block is constructed by providing a controller, additionally having a set maintenance function of the present invention, to a general pilot channel searcher block of the MS. The controller can also employ a general controller provided for the MS.

The pilot channel signal of the base station is received through an antenna 701 and a receiver 703, is separated into an in-phase (I) component and a quadrature (Q) component, and is input to a despreader 705. A PN generator 715 and a PN masker 717 generate PN codes corresponding to PN offsets under the control of the controller 719. The despreader 705 despreads the I and Q signal components using the received PN codes. A coherent accumulator 707 sequentially accumulates and calculates the despreaded signals, and transmits the signals to an energy calculator 709.

The energy calculator 709 squares and adds the accumulated I and Q signal components, and calculates the strength of the pilot channel signal. A non-coherent accumulator 711 accumulates the strength of the obtained signal for a time period, and calculates an average value. A sorter 713 sorts an average energy calculated for the pilot offsets (PN offsets) of each set. A controller 719 reads the sorted average energy, and performs an acquisition, a finger assignment, and a set maintenance of the pilot channel according to a routine. In other words, the controller 719 controls the set range to be searched and the search rate.

A memory 721 stores the pilot offset of each set for pilot search and set maintenance of the controller 719, the search result, and A set list, C set list, N set list, and R set list. In FIG. 7, the memory 721 can be built in the controller 719. The controller 719 is shown as one block of the controller of the MS for scheduling an operation of the pilot channel searcher block with reference to the pilot offsets of the respective sets according to an exemplary set maintenance method of the present invention, giving a search command on the basis of the search rate and a search sequence defined for the respective sets, and performing software processing depending on the search result.

Thus, the controller 719 searches a magnitude, that is, the energy of the pilot channel signal received from the base station corresponding to the pilot offset of each set. The controller 719 periodically searches the peripheral sets, updates the path and the path position, that is, path information of the pilot signals received from the base stations of the respective sets, and energy information of the pilot signal, and determines whether or not it is under an environment where a handoff is needed. On the basis of the search result, that is, on the basis of the comparison result of comparing the change value of the path position of the pilot signals received from the base stations of the respective sets with the threshold, the controller 719 determines whether or not the MS moves, and decides a current stability state and controls its dependent search mode.

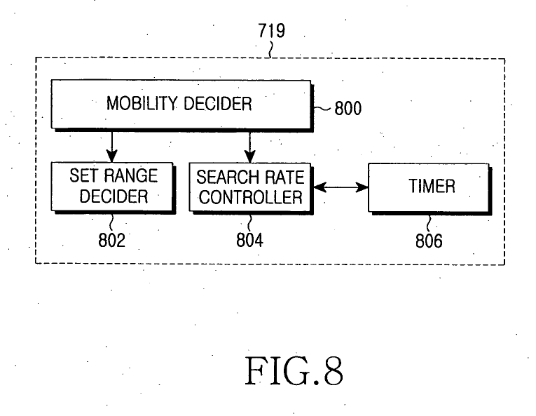

In other words, when the strength of the measured pilot channel signal is greater than the strength of the minimum pilot signal, and the change value of the path position of the pilot signal is greater than the threshold, the controller 719 increases the stability, and changes the search mode as described with reference to FIGS. 5 and 6. Changing the search mode according to a first exemplary embodiment of the present invention, the controller 719 decides the range of the set to be searched depending on the measured stability. Changing the search mode according to a second exemplary embodiment of the present invention, the controller 719 changes the search rate. Thus, a construction of the controller 719 according to an exemplary embodiment of the present invention will be described with reference to FIG. 8.

FIG. 8 is a block diagram illustrating a construction of the controller 719 according to an exemplary embodiment of the present invention. A mobility decider 800 periodically searches the base stations included in the peripheral sets, measures the path position or an amount of variation of the energy of the pilot signal within a time period using the search result, and calculates how fast the MS moves. A set range decider 802 decides the range of the set that the searcher block needs to search, depending on the decision result of the mobility decider 800 according to a first exemplary embodiment of the present invention. A search rate controller 804 controls the search rate of the searcher block depending on the decision result of the mobility decider 800 according to a second exemplary embodiment of the present invention. The search rate controller 804 sets the set search period, and controls the timer 806 to count the search period.

FIG. 8 shows the set range decider 802 according to a first exemplary embodiment of the present invention, together with the search rate controller 804 and the timer 806 according to a second exemplary embodiment of the present invention, but they can be also provided separately according to each exemplary embodiment.

In the case of combining the first and second exemplary embodiments, the resources of the MS can be saved.

As described above, when the set maintenance for a pilot channel search is performed in the mobile communication system, if the MS has high stability and the range of the set to be searched is reduced, the search period of the set can be shortened, thereby obtaining more accurate path position information of the sets.

If the search period is fixed and the number of the sets is reduced, the number of times of search versus a time period can be reduced, thereby saving the resource of the MS. On the contrary, in low stability, the MS is controlled and operated in the general search mode, and relatively widens the range of the set to be searched, thereby maintaining the call quality even when moving at high speed.

Certain exemplary embodiments of the present invention can also be embodied as computer-readable codes on a computer-readable recording medium. The computer-readable recording medium is any data storage device that can store data which can thereafter be read by a computer system. Examples of the computer-readable recording medium include, but are not limited to, read-only memory (ROM), random-access memory (RAM), CD-ROMs, magnetic tapes, floppy disks, optical data storage devices, and carrier waves (such as data transmission through the Internet). The computer-readable recording medium can also be distributed over network-coupled computer systems so that the computer-readable code is stored and executed in a distributed fashion. Also, functional programs, codes, and code segments for accomplishing the present invention can be easily construed as within the scope of the invention by programmers skilled in the art to which the present invention pertains.

While the invention has been shown and described with reference to a certain exemplary embodiment thereof, it will be understood by those skilled in the art that various changes in form and details may be made therein without departing from the spirit and scope invention as defined by the appended claims.

What is claimed is:

1. A method for maintaining pilot offsets in a mobile station of a mobile communication system, the method comprising:
receiving a pilot signal from a base station of at least one active set;
determining a change value based on a variation of a path position of the pilot signal; and
controlling a set search range depending on the determined change value.

2. The method of claim 1, wherein the path position comprises a temporal point where a main peak of the pilot signal is positioned for a time period.

3. The method of claim 1, wherein the controlling of the set search range comprises:
comparing the change value of the path position with a threshold; and
controlling a search range of a neighbor set to be searched by the mobile station when the change value of the path position is less than the threshold.

4. The method of claim 3, further comprising controlling a set search period when the change value of the path position is less than the threshold.

5. The method of claim 3, wherein the controlling of the set search period comprises reducing the number of the neighbor sets to be searched, and decreasing a search rate.

6. The method of claim 3, wherein the controlling of the set search period comprises decreasing a search rate.

7. The method of claim 1, wherein the change value comprises a number of accumulation chips representing an extent of a change of the path position calculated depending on a variation of the path position.

8. A pilot channel searcher block of a mobile station for maintaining pilot offsets in a mobile communication system, the searcher block comprising:
a despreader for receiving a pilot channel signal from base stations of at least one active set through an antenna, and despreading an I (In-phase) component and a Q (Quadrature) component of the received pilot channel signal using PN codes;
a PN generator for generating the PN codes depending on a control signal;
a coherent accumulator for accumulating the despreaded signals;
an energy calculator for calculating an energy value of the accumulated signals;
a non-coherent accumulator for accumulating the calculated energy value for a time period, and calculating an average energy value;
a sorter for sorting the average energy value for the pilot offsets; and
a controller for receiving the pilot channel signal from the base stations, determining a change value based on a variation of a path position of the pilot signal, and controlling a set search range depending on the change value of the path position.

9. The searcher block of claim 8 wherein the path position comprises a temporal point where a main peak of the pilot signal is positioned, for a time period

10. The searcher block of claim 8, wherein the controller compares the change value of the path position with a threshold, and controls a search range of a neighbor set to be searched by the mobile station when the change value of the path position is less than the threshold.

11. The searcher block of claim 10, wherein the controller controls a set search period when the change value of the path position is less than the threshold.

12. The searcher block of claim 11, wherein the controller reduces the number of neighbor sets to be searched.

13. The searcher block of claim 11, wherein the controller decreases a search rate.

14. The searcher block of claim 8, wherein the change value comprises the number of accumulation chips representing an extent of a change of the path position calculated depending on a variation of the path position.

15. A method for maintaining pilot offsets in a mobile station, the method comprising:
receiving a signal by a mobile station;
determining a rate of change of the location of the mobile station based on a variation of the received signal;
controlling a set search range depending on the determined rate of change.

16. The method of claim 15, wherein the determining of the rate of change comprises determining a variation of a path position comprising a temporal point where a main peak of the pilot signal is positioned for a time period.

17. The method of claim 15, wherein the controlling of the set search range comprises:
comparing the rate of change with a threshold; and
controlling a search range of a neighbor set to be searched by the mobile station when the rate of change is less than the threshold.

18. The method of claim 17, further comprising controlling a set search period when the rate of change is less than the threshold.

19. The method of claim 18, wherein the controlling of the set search period comprises reducing the number of the neighbor sets to be searched, and decreasing a search rate.

20. The method of claim 17, wherein the controlling of the set search period comprises decreasing a search rate.

21. A pilot channel searcher block of a mobile station for maintaining pilot offsets in a mobile communication system, the searcher block comprising:
a controller for receiving a pilot channel signal from base stations of at least one active set, determining a change value based on a variation of a path position of the pilot signal, and controlling a set search range depending on the change value of the path position.

22. The searcher block of claim 21, wherein the path position comprises a temporal point where a main peak of the pilot signal is positioned, for a time period

23. The searcher block of claim 21, wherein the controller compares the change value of the path position with a threshold, and controls a search range of a neighbor set to be searched by the mobile station when the change value of the path position is less than the threshold.

24. The searcher block of claim 23, wherein the controller controls a set search period when the change value of the path position is less than the threshold.

25. The searcher block of claim 24, wherein the controller reduces the number of neighbor sets to be searched.

26. The searcher block of claim 24, wherein the controller decreases a search rate.

27. The searcher block of claim 21, wherein the change value comprises the number of accumulation chips representing an extent of a change of the path position calculated depending on a variation of the path position.

28. A computer readable medium having stored thereon instructions for executing a method for maintaining pilot offsets in a mobile station of a mobile communication system, the instructions comprising:
a first set of instructions for receiving a pilot signal from a base station of at least one active set;
a second set of instructions for determining a change value based on a variation of a path position of the pilot signal; and
a third set of instructions for controlling a set search range depending on the determined change value.
